(19) United States
(12) Patent Application Publication
(10) Pub. No.: US 2018/0083773 A1
(43) Pub. Date: Mar. 22, 2018

(54) INFORMATION SECURITY DEVICE AND INFORMATION SECURITY METHOD USING ACCESSIBILITY

(71) Applicant: TRANSBOX CO., LTD., Seoul (KR)

(72) Inventor: In-Kook PARK, Seoul (KR)

(21) Appl. No.: 15/825,069

(22) Filed: Nov. 28, 2017

Related U.S. Application Data
(63) Continuation of application No. PCT/KR2016/009545, filed on Aug. 26, 2016.

(30) Foreign Application Priority Data
Aug. 26, 2015 (KR) 10-2015-0120303

(51) Int. Cl. H04L 9/08; G06F 21/62; G06F 21/83; G06F 21/60

(52) U.S. Cl. CPC H04L 9/08; G06F 21/629; H04W 12/02; G06F 21/602; G06F 21/83

(57) ABSTRACT

An information security device may comprise at least one processor; memory; and one application stored in the memory and executable by the at least one processor, the one application comprising instructions to: receive one or more characters, which are input to an other application, from the other application through an accessibility feature; encrypt the one or more characters received from the other application; replace the one or more characters input to the other application with the encrypted one or more characters; receive one or more characters, which are output from the other application, from the other application through the accessibility feature; check whether the one or more characters output from the other application are encrypted; decrypt the one or more characters output from the other application; and output the decrypted one or more characters on the other application.

### CROSS-REFERENCE TO RELATED APPLICATIONS

This application is a continuation of International Application No. PCT/KR2016/009545 filed on Aug. 26, 2016, which claims the priority to Korean Patent Application No. 10-2015-012030 filed in the Korean Intellectual Property Office on Aug. 26, 2015, the entire contents of which are incorporated herein by reference.

### TECHNICAL FIELD

The present disclosure generally relates to information security technology, and more particularly, to an information security device and an information security method for maintaining security of information by encrypting and decrypting a character string obtained using an accessibility application programming interface (API).

### BACKGROUND

A smart terminal provides an accessibility feature or function. The accessibility function of the smart terminal supports the convenience of a user interface to the disabled. For example, if a visually impaired person sets the accessibility function on the smart terminal, the smart terminal outputs a text content, a focus/mouse position, a button name or the like of a screen as voice so that the visually impaired person may conveniently make an input according to the voice guidance.

The information security technique includes encryption and decryption techniques. The security of data may be maintained by encryption and decryption. Also, if a user is set to have authority for encryption and decryption, the security of the user for accessing data is maintained. For example, a first user who creates and stores information encrypts data and then stores or transmits the data. Here, the first user may designate a second user to be set to have authority for decrypting the encrypted data. If so, only the authorized second user is able to decrypt the encrypted data, so the security of the information may be maintained.

### RELATED LITERATURES

### Patent Literature

Korean Patent Registration No. 10-1173583 (Aug. 7, 2012)

### SUMMARY

Some embodiments of the present disclosure may provide an information security device and an information security method, which may access and bring an input character and an output character based on the accessibility of a smart terminal, and encrypt and decrypt the brought character to maintain the security of the information.

In one aspect of the present disclosure, an information security device may execute a first application comprising: an input character receiving unit configured to receive one or more input characters, which are input to a second application, by an accessibility feature; an input character encrypting unit configured to encrypt the input characters into one or more encrypted characters; an encrypted character substituting unit configured to replace the characters input to the second application with the encrypted characters; an output character receiving unit configured to receive one or more output characters, which are output from the second application, by the accessibility feature; a decryption determining unit configured to check whether the output characters are encrypted and determine whether or not to decrypt the output characters; an output character decrypting unit configured to decrypt the output characters into one or more original characters, if it is determined to decrypt; and an original character output unit configured to output the original characters on the output characters of the second application in an overlay manner.

In an exemplary embodiment, when the input characters are selected by a user, the input character receiving unit may display a button, icon or any interface for commanding encryption on a screen of the second application, and when the displayed button is selected by the user, the input character receiving unit may receive the input characters.

In another exemplary embodiment, the input character encrypting unit may encrypt the input characters into encrypted characters which include inherent or unique identification information for inherently or distinctively identifying that the input characters are encrypted.

In addition, any least one of inputting, outputting, storing and communicating may be performed to the encrypted character according to an inherent feature or function of the second application.

In another still exemplary embodiment, when the output characters are selected by the user, the output character receiving unit of the first application may receive the output characters from the second application, and when the inherent identification information is identified from the received output characters, the decryption determining unit of the first application may display a button, icon or any interface for commanding decryption on a screen of the second application, and when the displayed button is selected by the user, the decryption determining unit of the first application may determine to decrypt the output characters.

Here, the information security device may perform the encryption and the decryption in a pretty good privacy (PGP) manner based on a single key or a public key.

According to another embodiment of the present disclosure of an information security device, the input character encrypting unit of the first application may transmit identification information of a first user who has performed encryption and at least one second user who is allowed to perform decryption to an information security server and receive the inherent identification information from the information security server as a response.

Here, when the inherent identification information is identified from the received output characters, the decryption determining unit of the first application may transmit the identified inherent identification information and the user identification information to the information security server to request an allowance for decryption, and receive from the information security server a checking result whether the user identification information is checked from the identification information of the second user, and when the received checking result is an allowance for decryption, the decryption determining unit of the first application may display a button, icon or any interface for commanding decryption on a screen of the second application, and when the displayed button is selected by the user, the decryption determining unit of the first application may determine to decrypt the output characters.

According to another still embodiment of the present disclosure of an information security device, the input character encrypting unit of the first application may divide the encrypted characters into one or more first encrypted characters and one or more second encrypted characters, transmit the second encrypted characters to the information security server and request the second encrypted characters to be stored therein, and receive the inherent or unique identification information from the information security server as a response, and the encrypted character substituting unit of the first application may substitute the input character with the first encrypted character containing the inherent or unique identification information.

Here, when the inherent or unique identification information is identified from the received output characters, the decryption determining unit of the first application may transmit the identified inherent identification information and/or the user identification information to the information security server to request an allowance for decryption, and receive from the information security server a checking result whether the user identification information is checked from the identification information of the user who is allowed for decryption and the stored second encrypted characters, and when the received checking result is an allowance for decryption, the decryption determining unit of the first application may display a button, icon or any interface for commanding decryption on a screen of the second application , and when the displayed button is selected by the user, the decryption determining unit of the first application may determine to decrypt the output characters, and the output character decrypting unit of the first application may combine the first encrypted characters and the second encrypted characters and decrypt into the original characters.

In addition, the second encrypted characters stored in the information security server may be deleted by the user who has performed encryption to manage security.

In another aspect of the present disclosure, an information security device, which may provide information security service to a user terminal, may be configured with a server comprising: an encryption information registering unit configured to register an encryption key of information, user information having a decryption authority, and a partial character string of one or more encrypted characters; an inherent information responding unit configured to generate inherent identification information for inherently identifying the registered encryption information as a response; a decryption request receiving unit configured to receive the inherent identification information to receive a request for decryption; and a decryption information providing unit configured to check decryption authority of a user by using the inherent identification information, and provide the registered partial character string and decryption information containing the encryption key as a decryption key when the decryption authority is valid.

In another aspect of the present disclosure, an information security method, which is executed by an information security device, may comprise: (a) an input character receiving step for receiving one or more input characters, which are input to a second application, by an accessibility feature or function; (b) an input character encrypting step for encrypting the input characters into one or more encrypted characters; (c) an encrypted character substituting step for substituting the input characters in the second application with the encrypted characters; (d) an output character receiving step for receiving one or more output characters, which are output from the second application, by the accessibility feature or function; (e) a decryption determining step configured to check whether the output characters are encrypted and determine whether or not to decrypt the output characters; (f) an output character decrypting step for decrypting the output characters into original characters, if it is determined to decrypt; and (g) an original character output step for outputting the original characters on the output characters of the second application in an overlay manner.

According to some embodiments of the present disclosure, since one user who has generated information encrypts the information and another user who accesses the information decrypts the encrypted character, the end-to-end protection service may be provided for the information between the users, and thus the confidentiality of information may be maintained from a user terminal and an information provider.

According to some embodiments of the present disclosure, only a user having decryption authority of information may be allowed to decrypt the information by using a public key-based encryption and decryption method.

According to some embodiment of the present disclosure, encryption information may be divided and a part of the information may be stored in a server to improve the security of the information, and the information may be discarded at the request of a user who performs the encryption, thereby endowing a life cycle for the information.

In some embodiments, an information security device may comprise: at least one processor; memory; and one application stored in the memory and executable by the at least one processor, the one application comprising instructions to: receive one or more characters, which are input to an other application, from the other application through an accessibility feature; encrypt the one or more characters received from the other application; replace the one or more characters input to the other application with the encrypted one or more characters; receive one or more characters, which are output from the other application, from the other application through the accessibility feature; check whether the one or more characters output from the other application are encrypted; decrypt the one or more characters output from the other application; and output the decrypted one or more characters on the other application.

In some embodiments, the one application may display the encrypted or decrypted one or more characters on the input or output one or more characters of the other application in an overlay manner.

In some embodiments, the one application, when the one or more characters input to the other application are selected by a user, may receive the input one or more characters from the other application through the accessibility feature and provide an interface for requesting encryption of the input one or more characters on a screen of the other application.

In some embodiments, the encrypted one or more characters may include information indicating that the one or more characters output from the other application are encrypted.

In some embodiments, the one application, when information indicating that the output one or more characters are encrypted is included in the one or more characters output from the other application, may provide an interface for requesting decryption of the output one or more characters on a screen of the other application.

In some embodiments, the one application, when the one or more characters encrypted and output from the other application are selected by a user, may receive the output one or more characters from the other application through the accessibility feature and provide an interface for requesting decryption of the output one or more characters on a screen of the other application.

In some embodiments, the one application may transmit, to a server, information of a first user who has performed encryption and one or more second users who have authority for decryption, and the one application may receive, from the server, information indicating that one or more characters are encrypted.

In some embodiments, the one application, when the one or more characters output from the other application include unique identification information indicating that the output one or more characters are encrypted, may send user identification information of the information security device's user and the unique identification information to a server.

In some embodiments, the server may check whether the user identification information sent from the one application corresponds to information of one or more users, having decryption authority, which are stored in the server, and the one application may provide an interface for requesting decryption of the output one or more characters on a screen of the other application.

In some embodiments, when the server determines that the information security device's user has decryption authority, the one application may receive a decryption key from the server and decrypts the one or more characters output from the other application by using the decryption key.

In some embodiments, the one application may check whether the one or more characters output from the other application are encrypted by using unique identification information indicating that one or more characters are encrypted. The unique identification information may be included in the one or more characters output from the other application.

In some embodiments, the one application may divide the encrypted one or more characters into a first character set and a second character set, send the first character set of the divided characters to an other information security device, and send the second character set of the divided characters to a server so that the server stores the second character set of the divided characters.

In some embodiments, the one application may receive the second character set of the divided characters from the server and combine the first character set of the divided characters and the second character set of the divided characters received from the server.

In some embodiments, an information security method may comprise: receiving, by one application, one or more characters, which are input to an other application, from the other application through an accessibility feature, the one application and the other application stored in memory and executable by at least processor; encrypting, by the one application, the one or more characters received from the other application; replacing, by the one application, the one or more characters input to the other application with the encrypted one or more characters; receiving, by the one application, one or more characters, which are output from the other application, from the other application through the accessibility feature; checking, by the one application, whether the one or more characters output from the other application are encrypted; decrypting, by the one application, the one or more characters output from the other application; and outputting, by the one application, the decrypted one or more characters on the other application.

In some embodiments, the one application may display the encrypted or decrypted one or more characters on the input or output one or more characters of the other application in an overlay manner.

In some embodiments, the one application, when the one or more characters input to the other application are selected by a user, may receive the input one or more characters from the other application through the accessibility feature and provide an interface for requesting encryption of the input one or more characters on a screen of the other application.

In some embodiments, the encrypted one or more characters may include information indicating that the one or more characters output from the other application are encrypted.

In some embodiments, the one application, when the one or more characters encrypted and output from the other application are selected by a user, may receive the output one or more characters from the other application through the accessibility feature and provide an interface for requesting decryption of the output one or more characters on a screen of the other application.

In some embodiments, the one application may transmit, to a server, information of a first user who has performed encryption and one or more second users who have authority for decryption, and the one application may receive, from the server, information indicating that one or more characters are encrypted.

In some embodiments, the one application may divide the encrypted one or more characters into a first character set and a second character set, send the first character set of the divided characters to an other information security device, and send the second character set of the divided characters to a server so that the server stores the second character set of the divided characters.

### BRIEF DESCRIPTION OF DRAWINGS

The accompanying drawings illustrate exemplary embodiments of the present disclosure and together with the foregoing disclosure, serve to provide further understanding of the technical features of the present disclosure, and thus, the present disclosure is not construed as being limited to the drawings.

FIG. 1 is a schematic view showing information security devices according to a first embodiment of the present disclosure.

FIG. 2 is a schematic view showing information security devices and an information security server according to a second embodiment of the present disclosure.

FIG. 3 is a schematic view showing information security devices and an information security server according to a third embodiment of the present disclosure.

FIGS. 4a and 4b show exemplary interfaces for sending a security message for an information security device according to an embodiment of the present disclosure.

FIG. 5 show exemplary interfaces for receiving a security message for an information security device according to an embodiment of the present disclosure.

FIGS. 6a and 6b are flowcharts for illustrating information security methods according to embodiments of the present disclosure.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

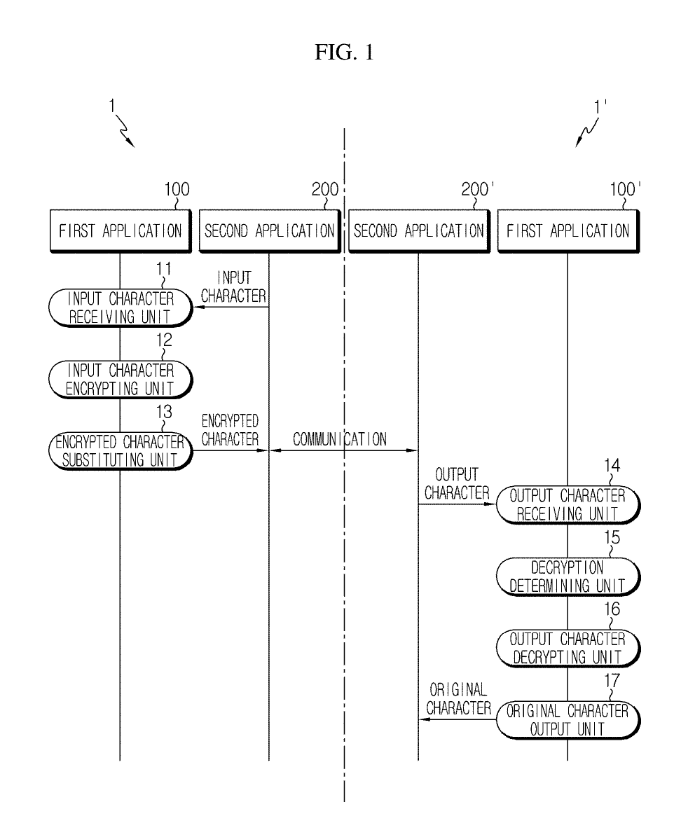

FIG. 1 is a schematic view showing an information security device 1 according to a first embodiment of the present disclosure.

An information security device 1 or 1′ of the present disclosure may employ any information communication terminal having one or more applications executing instructions or functions without special limitations. For example, a computer terminal, a smart terminal or the like may be used as the information security device 1 or 1′.

A first application 100 or 100′ may be installed and executed in the information security device 1 or 1′ to provide information security service by encrypting and decrypting information. The first application 100 or 100′ may encrypt one or more input characters which are input to a second application 200 or 200′ executed at the information security device 1, decrypt the encrypted characters output from the second application 200 or 200′, and output the decrypted characters which correspond to original characters.

The second application 200 or 200′ may be any application which is installed or executed in the information security device 1 without any special limitations. For example, the information security device 1 may be a smart terminal, and the second application 200 or 200′ may be a memo application, an address book application or a social networking service (SNS) application executed at the smart terminal.

For example, the second application 200 or 200′ may be a memo program having a locally executed function without a communication function. A user may input characters “111-222-34567/8901” as ‘account/password’ by using the second application 200 or 200′ and request the first application 100 or 100′ to encrypt the characters input by the user. In response to the user's request, the first application 100 may encrypt the input characters and replace the original input characters “111-222-34567/8901” with encrypted characters “A0789bcd&*0090!65”. Then, the second application 200 or 200′ may store the encrypted characters as a memo content according to the request of the user. After that, the second application 200 or 200′ may output the encrypted characters on a screen according to the request of the user. If the user requests decryption to the first application 100 or 100′, the first application 100 or 100′ may decrypt the encrypted character “A0789bcd&*0090!65” output on the screen and display the original character “111-222-34567/8901”. Thus, the user may store an important content of the memo application as encrypted characters and decrypt and check their original characters whenever required.

As another example, the second application 200 or 200′ may be a message program having a communication function. The user inputs characters “111-222-34567/8901” as ‘account/password’ by using the second application 200 and requests encryption to the first application 100. The first application 100 encrypts the input characters and substitutes the original input characters “111-222-34567/8901” with encrypted characters “A0789bcd&*0090!65”. Then, the second application 200 receives the encrypted characters as a message content from the first application 100. After that, the second application 200 transmits the encrypted characters to a message receiver according to the request of the user. If the receiver receives the message, the second application 200′ of an information security device of the receiving party outputs the received encrypted character on a screen. If the receiver requests decryption to the first application 100′, the first application 100′ decrypts the encrypted characters “A0789bcd&*0090!65” output on the screen and displays the original characters “111-222-34567/8901”. Thus, the user may transmit an important content of the message application as encrypted characters by communication and decrypt and check their original characters whenever required.

Here, if the information security is communication security, the data transmitted during the communication process may be encrypted and thus protected against a third party. Therefore, after the communication is completed, since one or more original characters are displayed at the communication terminal, the information security may be weak. In addition, a service provider of the program of the communication terminal may be accessible to data of the user, so the security may be weak. However, the present disclosure may provide user-to-user encryption and decryption service, and thus only the user may serve as the subject of information security. Thus, some exemplary embodiments of the present disclosure may provide information security, independent from the communication security as well as the service provider.

For reference and convenience of explanation, FIG. 1 depicts that the second application 200 is assumed as being a message program which transmits encrypted characters to another party by communication. Hereinafter, it is assumed that the information security service is accompanied by a wired or wireless communication between a sender and a receiver.

The information security device 1 or 1′ according to the first embodiment of the present disclosure may execute a first application 100 or 100′. The first application 100 or 100′ may include an input character receiving unit 11, an input character encrypting unit 12, an encrypted character substituting unit 13, an output character receiving unit 14, a decryption determining unit 15, an output character decrypting unit 16 and an original character output unit 17. The units identified above may correspond to sets of instructions for performing functions described herein. The sets of instructions can be stored at memory and/or executed by one or more processors. The above identified units (i.e., sets of instructions) need not be implemented as separate software programs, procedures, modules or units, and thus various subsets of these programs or units and data structures. The memory may store additional units and data structures not described herein.

The input character receiving unit 11 may receive one or more input characters which are input to the second application 200 or 200′. The input character encrypting unit 12 may encrypt the received input characters into one or more encrypted characters. The encrypted character substituting unit 13 may substitute the input characters with the encrypted characters. The output character receiving unit 14 may receive one or more output characters output from the second application 200 or 200′. The decryption determining unit 15 may check whether the received output characters are encrypted and determine whether or not to decrypt the output characters. The output character decrypting unit 16 may decrypt the output characters, which are determined to be decrypted, into the original characters. The original character output unit 17 may output the decrypted original characters to the output characters in an overlay manner.

In an exemplary embodiment illustrated in FIG. 1, the input character receiving unit 11 may receive or access one or more input characters input to the second application 200 by means of an accessibility function. The input characters may be input to the second application 200 through, for example, but not limited to, an input window or an edit box, and the input character receiving unit 11 may bring the input characters input to the second application 200 by using the accessibility function of an operating system (OS).

Here, when one or more of the input characters displayed on the screen are selected by the user, the input character receiving unit 11 may display a button, icon or interface for commanding encryption on the screen, and if the displayed button is selected by the user, the input character receiving unit 11 may receive the selected input characters. For example, the user may select a specific area of the input characters in order to bring the input characters. Accordingly, while inputting one or more characters into the second application 200, the user may select the input characters if information security is necessary. If the user selects the input characters, the first application 100 may display the button of encryption command.

If the user requests the encryption by pressing or clicking the encryption button, the input character encrypting unit 12 may encrypt the input characters received by using the accessibility function. The encrypted characters may include inherent or unique identification information for distinctively identifying that the input characters are encrypted. In other words, if the unique identification information is identified from or included in a character string, it may be determined that the character string is encrypted.

Here, the input character encrypting unit 12 may generate one or more encrypted characters, for example, but not limited to, in a pretty good privacy (PGP) encryption manner based on a single key or a public key. Thus, a corresponding decryption manner may be applied to the encrypted character.

The encrypted character substituting unit 13 may replace or substitute the input characters corresponding to original characters with the encrypted characters. After the input characters are replaced with the encrypted characters, the user who has entered the input characters also cannot check the original characters unless the encrypted characters are decrypted. After that, the second application 200 may perform at least one of inputting, outputting, storing and communicating processes according to an inherent function of the second application 200. The second application 200 of the information security device 1 may transmit data including the encrypted characters to the second application 200′ of the information security device 1′ through communication.

The output character receiving unit 14 of the first application 100′ may receive one or more characters received from the second application 200′, output or displayed on the screen by the second application 200′, using an accessibility function. If the characters output or displayed on the screen is selected by the user, the output character receiving unit 14 may bring or access the output characters by using the accessibility function of the OS.

Here, since the output characters displayed on the screen of the second application 200′ are encrypted characters and look like random number/letter sequence, only the user who already knows that the output characters are encrypted characters is able to select the encrypted characters, thereby maintaining the security of the information.

The decryption determining unit 15 may determine whether the output characters received by the accessibility function include unique identification information. If the unique identification information is identified from the output characters received by the accessibility function, the decryption determining unit 15 may display a button for commanding decryption on the screen. If the unique identification information is not identified, the button for commanding decryption may not be displayed because that may mean that the output characters are not encrypted characters. If the user selects, touches or clicks the button for commanding decryption, the decryption determining unit 15 may determine to decrypt the output characters on the screen.

If the decryption determining unit 15 determines to perform decryption of the output characters, the output character decrypting unit 16 may decrypt the output characters by a decryption key to generate the original characters. The output character decrypting unit 16 may decrypt the output characters by applying a decryption method corresponding to the encryption method of the input character encrypting unit 12.

For example, message data may contain the decryption key, and the output character decrypting unit 16 may decrypt the output characters by using the received decryption key. If the received decryption key is encrypted using the public key of the receiver, decryption of the decryption key of the message by using the private key of the receiver may be needed.

The original character output unit 17 may display the decrypted original characters on the encrypted characters output by the second application 200 in an overlay manner. The user can check the original characters through the overlay window when necessary. The original character output unit 17 may close the overlay window according to a request of the user.

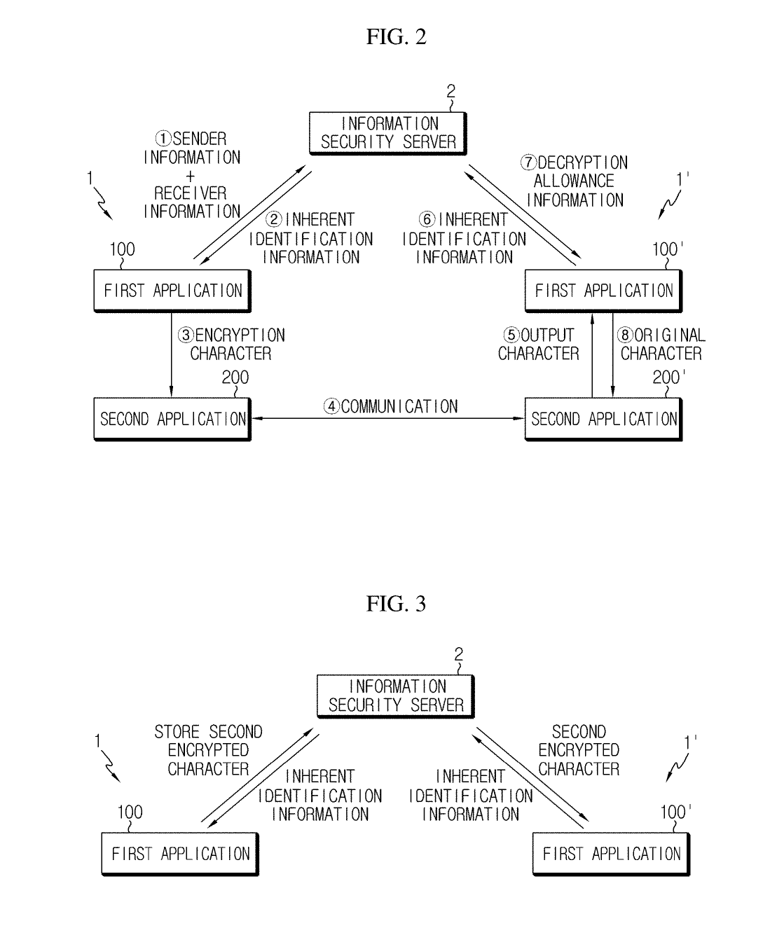

FIG. 2 is a schematic view showing information security devices 1 and 1′ and an information security server 2 according to a second embodiment of the present disclosure.

Unlike the first embodiment of the present disclosure described above, the second embodiment of the present disclosure may further comprise the information security server 2. The information security server 2 may manage decryption authority of a user for one or more encrypted characters. The configuration of the first embodiment may apply equally to the second embodiment unless described otherwise. Hereinafter, the same structure as the first embodiment will not be described in detail and only the different features are explained in detail.

The input character encrypting unit 12 of the first application 100 of a sender may transmit sender information and/or receiver information to an encryption information registering unit of the information security server 2 during an encryption process to request to generate unique identification information (\textcircled{1}). The input character encrypting unit 12 of the first application 100 of the sender may receive the unique identification information corresponding to the sender and/or receiver information from an unique information responding unit of the information security server 2 (\textcircled{2}). Then, the input character encoding unit 12 of the first application 100 of the sender may generate one or more encrypted characters containing the received inherent identification information (\textcircled{3}). The second application 200 of the sender may transmit the encrypted characters to the second application 200′ of a receiver by communication (\textcircled{4}).

For example, the input character encrypting unit 12 of the first application 100 of the sender may transmit the identification information of a first user (i.e. a sender) who has performed encryption and at least one second user (i.e. a receiver) who is allowed to perform decryption to the information security server 2, and receive the unique identification information from the inherent information responding unit of the information security server 2 as a response. The identification information of the second user may be specified for an individual user or whole users.

Meanwhile, the encryption information registering unit of the information security server 2 may encrypt the encryption key of the message by using the public key of the receiver according to the receiver setting of the sender and may store it as a decryption key of a message of each receiver.

The second application 200′ of the receiver may output the encrypted characters on the screen. If the user (i.e. a receiver) selects the characters displayed on the screen of the second application 200′, the output character receiving unit 14 of the first application 100′ of the receiver may receive the output characters by means of the accessibility function or feature (\textcircled{5}). If the unique identification information is identified from the received output characters, the decryption determining unit 15 of the first application 100′ of the receiver may transmit the identified unique identification information and the user identification information of the receiver to a decryption request receiving unit of the information security server 2 to request an allowance for decryption (\textcircled{6}). A decryption information providing unit of the information security server 2 may check whether the received user identification information is identical to, corresponds to or matches the user identification information having decryption authority set by the sender. The decryption determining unit 15 of the first application 100′ of the receiver may receive the checking result of the user identification information from the decryption information providing unit of the information security server 2. Then, if the received checking result is an allowance for decryption, the decryption determining unit 15 of the first application 100′ of the receiver may display a button, icon or any interface for a decrypting command on the screen, and if the displayed button is selected by the user (i.e. a receiver), the decryption determining unit 15 of the first application 100′ of the receiver may determine to decrypt the output characters (\textcircled{7}).

If the user (i.e. a receiver) selects one or more characters without a decryption authority, description is not allowed, and thus the button, icon or any interface for the decryption command may not be displayed on the screen of the second application 200′. Thus, the user who is not allowed for decryption is unable to check whether the corresponding output characters are encrypted characters or original characters. In other words, decryption is allowed only for an user having authority, and thus security can be maintained.

If decryption is allowed for the receiver, the decryption determining unit 15 of the first application 100′ of the receiver may receive decryption allowance information containing the decryption key of the stored message from the decryption information providing unit of the information security server 2. The output character decrypting unit 16 of the first application 100′ of the receiver may decrypt the encrypted characters by using the decryption key of the received message, and may display the decrypted original characters on the output characters of the second application 200′ to overlay thereon (\textcircled{8}). Here, if the public key is used, the first application 100′ may decrypt the decryption key of the received message by using the private key of the receiver, and may decrypt the encrypted characters by using the decrypted decryption key.

Thus, in the second embodiment, the information security server 2 may designate a user with decryption authority, check the decryption authority for the decryption request of the user, and provide a decryption key only for the user with valid decryption authority, thereby maintaining security of the user.

FIG. 3 is a schematic view showing an information security server 2 storing a part of encrypted characters and information security devices 1 and 1′ according to a third embodiment of the present disclosure.

In the third embodiment of the present disclosure, an encryption information registering unit of the information security server 2 may store a divided part of the encrypted characters, different from the first embodiment and the second embodiment of the present disclosure. The configuration of the first embodiment and the second embodiment may apply equally to the third embodiment unless described otherwise. Hereinafter, only the different features of the third embodiment will be explained in detail.

The input character encrypting unit 12 of the first application 100 of a sender may divide the encrypted characters into a plurality sets of characters during an encryption process, transmit a part or a set of the divided characters to the encryption information registering unit of the information security server 2 and request the part or set of the divided characters to be stored therein, and request to generate unique identification information. The sender may also set a user having decryption authority for the encrypted characters. It is assumed that the encrypted characters are divided into at least two sets, first encrypted characters and second encrypted characters, and the second encrypted characters are stored in the information security server 2.

The unique information responding unit of the information security server 2 may generate unique identification information, store the generated unique identification information in association with the identification information of the sender and the receiver, and transmit the unique identification information to the input character encrypting unit 12 of the first application 100 as a response.

The encrypted character substituting unit 13 of the first application 100 may substitute the input characters of the second application 200 with the first encrypted characters containing the unique identification information transmitted as a response. The first encrypted characters may be transmitted to the second application 200′ of the receiver through the second application 200 of the sender by communication.

The second application 200′ of the receiver may output the encrypted characters received from the sender on the screen. The decryption determining unit 15 of the second application 200′ of the receiver may transmit the unique identification information identified from the output characters on the screen to the decryption request receiving unit of the information security server 2 to request an allowance for decryption.

The decryption information providing unit of the information security server 2 may check whether the received user identification information corresponds to or match the user identification information having decryption authority set by the sender. If the decryption authority of the receiver is valid, the information security server 2 may transmit the decryption key of the stored message and the second encrypted characters as a response.

The decryption determining unit 15 of the first application 100′ of the receiver may receive the decryption key and the second encrypted characters from the decryption information providing unit of the information security server 2, display a button, icon or any interface for receiving a decrypting command on the screen, and decrypt the output characters if the displayed button is selected by the user or decryption is requested by the user.

The output character decrypting unit 16 of the first application 100′ of the receiver may combine the first encrypted characters and the second encrypted characters, decrypt the combined encrypted characters by using the received decryption key, and display the decrypted original characters to overlay on the output characters of the second application 200′.

Thus, in the third embodiment, since the information security server 2 may store a part of the encrypted characters and provide the stored encrypted characters only to a user having valid decryption authority, the security of data is maintained

Here, if encryption data is divided and a part of data is stored in the server separately, the following advantages may be provided. First, input characters obtained in an input window by means of accessibility function have an increased data length due to the encrypted characters. The encrypted characters substitute with the input characters of the input window and thus may have a limit in length. Thus, if the encrypted characters exceed the length limit, the encrypted characters may be corrupted and may not be recovered again. For this reason, if the first encrypted characters have a length smaller than the length of the input characters and the remainder is stored as the second encrypted characters, data corruption may be prevented while satisfying the length limit. Next, if the second encrypted characters are stored in the information security server 2, the user who performs encryption has a right for discarding the second encrypted characters by endowing a life cycle to characters that need security. For example, the user performing encryption may set so that the second encrypted characters are automatically deleted from the information security server 2 after the receiver receives the second encrypted characters. The discarding method of the encryption user may be set in various ways, based on receiving times and receiving periods. However, if the encryption user discards the second encrypted characters before the receiver receives the second encrypted characters, the receiver is not able to decrypt the encrypted characters.

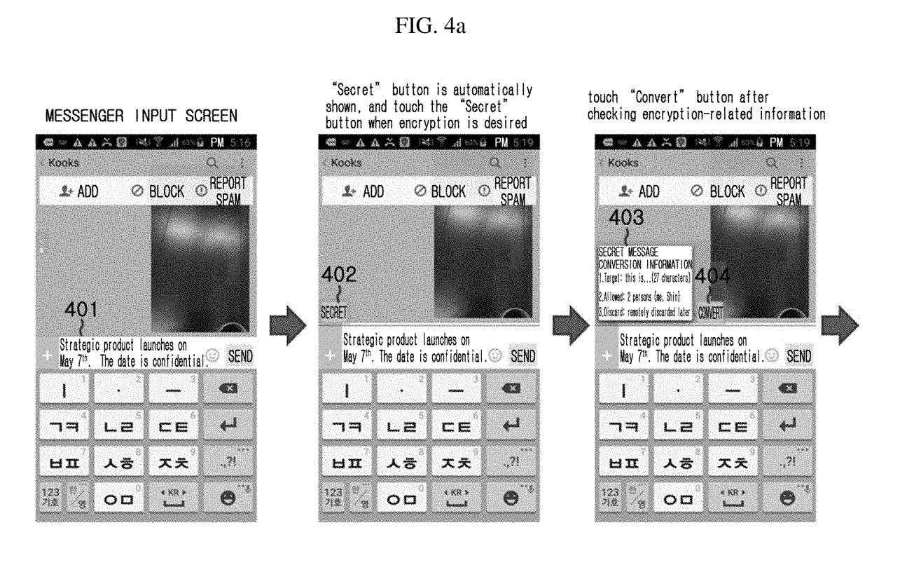

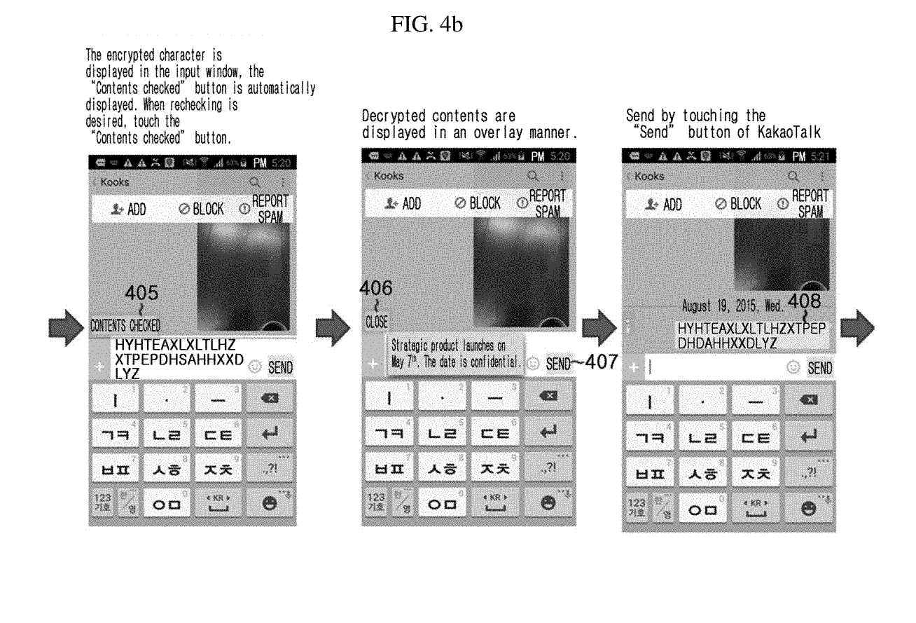

FIGS. 4a and 4b exemplarily show screens or interfaces for sending a security message for the information security device 1 according to an embodiment of the present disclosure.

For convenience of explanation, it is assumed that the information security device 1 is a smart terminal and the second application 200 is a messenger application (e.g., SNS message program) of the smart terminal.

Referring to FIG. 4a, after a user inputs a character string in an input window 401 of the message program, the user, if needing to encrypt the character string, may touch an area of the character string to select the character string. The first application 100 may display an encryption button 402 “SECRET” on the screen of the second application 200. If the user selects the encryption button 402, an option window 403 is generated on the screen of the second application 200 so that the user can set at least one or more encryption options. In the option window 403, the first application 100 may set encryption options such as an encryption target corresponding to the beginning and end of the character area, one or more receivers having decryption authority or the like. The option setting of the option window 403 may be omitted by the default setting of the user.

Referring to FIG. 4b, when a conversion button 404 “CONVERT” is selected by the user, the input characters of the input window 402 may be substituted with encrypted characters, and a decryption button 405 “CONTENTS CHECKED” for decrypting the encrypted characters into the original characters may be provided on the screen of the second application 200. If the decryption button 405 is selected by the user, the first application 100 may generate an overlay window to display the decrypted original characters on the screen of the second application 200, and may also display a closing button 406 “CLOSE”. In other words, after encrypting the character string, the user who has encrypted the character string is also able to check the original characters by selecting the decryption button 405. After that, if the user presses a sending button 407 “SEND” in the message program, the encrypted characters 408 are transmitted to the receiver.

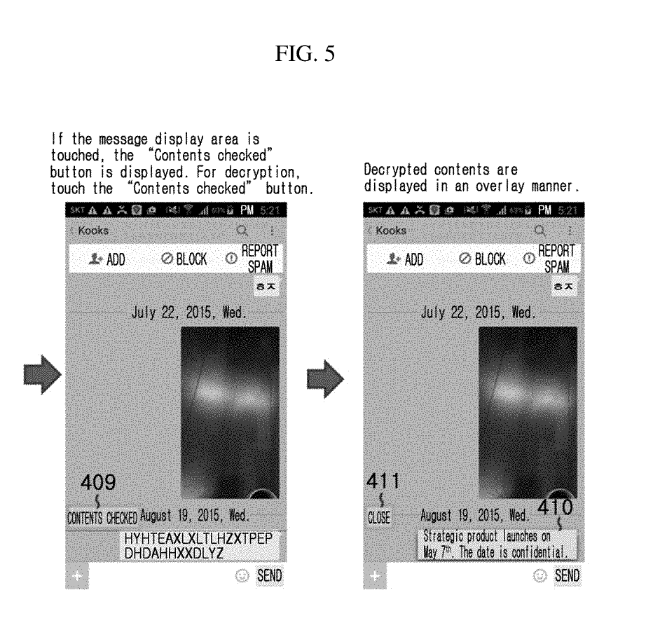

FIG. 5 exemplarily shows screens or interfaces for receiving a security message for the information security device 1 of FIG. 4 according to an embodiment of the present disclosure.

The second application 200′ of the information security device 1 of a receiver may receive encrypted characters and display the encrypted characters on the screen. The receiver may not exactly know whether character string displayed on the screen is encrypted characters or broken characters. If the receiver is informed by the sender that the displayed character string is encrypted characters, the receiver is able to know that the displayed character string is encrypted characters.

If the receiver touches the encrypted characters displayed on the screen of the second application 200′ of the information security device 1′ of the receiver, the first application 100′ of the information security device 1′ of the receiver may receive the character string by using the accessibility feature of function, extract the unique identification information from the received character string, determine whether the extracted unique identification information is valid, and output or provide a decryption button 409 “CONTENTS CHECKED” on the screen of the second application 200′ if the unique identification information is valid.

Thus, the decryption button 409 may be displayed only when the user (i.e. a receiver) recognizing that the received character string is encrypted characters touches the area of the character string on the screen of the second application 200′ of the information security device 1′ of the receiver, and therefore the security may be improved. In order to further improve the security, the first application 100′ of the information security device 1′ of the receiver may transmit an identification number (for example, a telephone number) of the receiver and/or the unique identification information to the information security server 2, receive a determination or verification result about the decryption authority from the information security server 2, and display the decryption button 409 on the second application 200′ only when the user (i.e. a receiver) has valid decryption authority according to the received determination or verification result. In some embodiments, it is desirable that the decryption button 409 may be displayed on the screen of the second application 200′ only for a user having a valid decrypting right.

If the decryption button 409 is selected by the user (i.e. a receiver), the first application 100′ of the information security device 1′ of the receiver may decrypt the character string on the screen of the second application 200′ by using a decryption key, and generate an overlay window 410 on the character string of the screen of the second application 200′ to temporarily display the decrypted original characters. If a closing button 411 “CLOSE” is selected by the user, the overlay window 410 is closed and the encrypted characters of the sender may be displayed on the screen of the second application 200′.

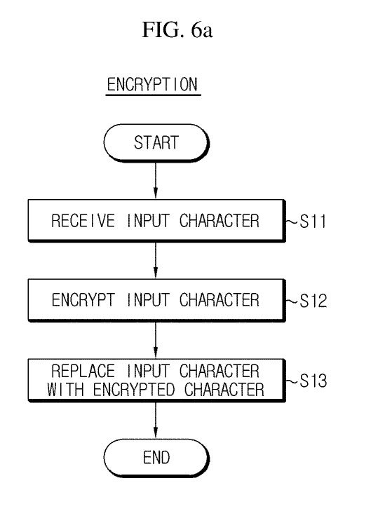

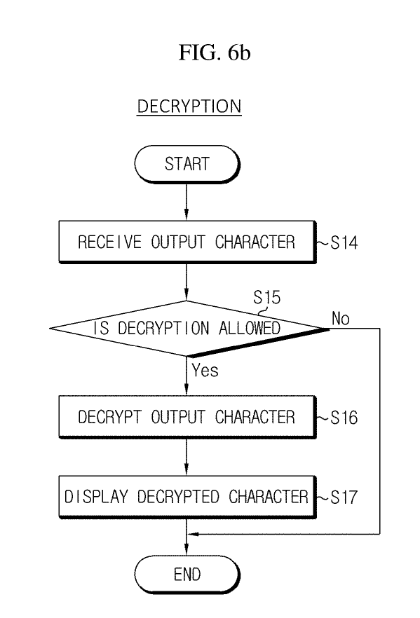

FIG. 6 is a schematic flowchart for illustrating an information security method according to the first embodiment of the present disclosure.

The user downloads the first application 100 or 100′ to the information security device 1 or 1′ and installs the first application 100 or 100′. If the user selects input character string while the character string is being input to any second application 200, the first application 100 may receive the input character string by using the accessibility function (S11). Then, the first application 100 may display the encryption button 402 on the screen of the second application 200.

If encryption is requested by the user, the first application 100 may encrypt the received character string by using the encryption key of the user to generate an encrypted character string (S12). In the first embodiment, the encrypted character string may contain inherent identification information and a decryption key corresponding to the encryption key. The first application 100 may replace or substitute the character string, input to the second application 200, with the encrypted character string (S13). After the encrypted character string is generated, the original character string may disappear and the original character string may be restored only by decrypting the encrypted character string. The user may store the encrypted character string or transmit the encrypted character string through a network according to the inherent function of the second application 200.

If the user defines or sets an encryption key, the user serving as a sender may notify the encryption key to a receiver only, and if the receiver inputs the encryption key as a decryption key, the security of information between the sender and the receiver may be maintained.

In a state where the encrypted characters may be output to or displayed on the screen of the second application 200′ of the information security device 1′ of the receiver, the first application 100′ of the information security device 1′ of the receiver, if the user selects the encrypted output character string on the screen, may receive the output character string from the second application 200′ based on the accessibility feature or function (S14).

If the output character string is received, the first application 100′ of the information security device 1′ of the receiver may extract an unique identification number and/or the decryption key from the output character string, and determine that decryption is possible or allowed if the unique identification number is valid (S15).

If decryption is possible or allowed, the first application 100′ of the information security device 1′ of the receiver may display the decryption button 405, 409 on the screen of the second application 200′, and if the decryption button 405, 409 is selected by the user, the first application 100′ may decrypt the output character string by using the decryption key (S16). The first application 100′ may display the decrypted original characters on the output character string displayed on the screen of the second application 200′ in an overlay manner (S17).

The second embodiment of the present disclosure may be applied to the above first embodiment as follows.

In the step S12, the first application 100 of the information security device 1 of a sender may transmit receiver information containing sender information and/or decryption authority to the information security server 2 to request generation of unique identification information. The first application 100 may receive the unique identification information from the information security server 2 and generate one or more encrypted characters containing the received unique identification information. Here, the information security server 2 may encrypt encryption key by using a public key of an individual receiver according to the receiver designation of the sender and store the encryption key as a decryption key for each receiver.

In the step S15, if the unique identification information is identified from the received output characters, the first application 100′ of the information security device 1′ of the receiver may transmit the identified unique identification information and/or the user identification information of the receiver to the information security server 2 and request an allowance for decryption. The information security server 2 may check whether the received user identification information is identical to, matches or corresponds user identification information of decryption authority set by the sender. If it is checked that they are identical, matched, or corresponded to each other, the first application 100′ of the information security device 1′ of the receiver may receive a result whether decryption is allowed or possible, from the information security server 2. If the received result is an allowance for decryption, the button 405 or 409 for commanding decryption may be displayed on the screen of the second application 200′ of the information device 1′ of the receiver. In addition, if decryption is allowed, the first application 100′ of the information security device 1′ of the receiver may receive decryption allowance information containing the stored decryption key from the information security server 2.

The third embodiment of the present disclosure may be applied to the first or second embodiment as follows.

In the S12, the first application 100 of the information security device 1 of a sender may divide encrypted characters into a plurality sets of characters during an encryption process, transmit at least one set or a part of the divided characters to the information security server 2 to request at least one set or the part of the divided characters to be stored, and request the information security server 2 to generate the unique identification information. For example, the encrypted characters may be divided into two sets, first encrypted characters and second encrypted characters. The second encrypted characters may be stored in the information security server 2. Then, the information security server 2 may generate unique identification information, and the first application 100 of the information security device 1 of the sender may replace or substitute the input characters of the second application 200 with the first encrypted characters containing the inherent identification information received from the information security server 2 (S13).

Here, the second encrypted characters stored in the information security server 2 may be discarded by the user (i.e. a sender) who has performed encryption. If the characters stored in the information security server 2 are discarded, the encrypted data characters are not able to be decrypted. The user may discard the characters after performing encryption and before decryption is performed by someone else. In another case, the user may designate a life cycle of the information by setting decryption times, decryption period or the like of the information.

In the step S15, the first application 100′ of the information security device 1′ of the receiver, if the unique identification information is identified from the received output characters, may transmit the identified unique identification information and/or the user identification information of the receiver to the information security server 2 and request an allowance for decryption. The information security server 2 may check whether the received user identification information is identical to or corresponds to user identification information of decryption authority set by the sender, and if the decryption authority is valid, an allowance result containing the stored second encrypted characters and the decryption key may be transmitted to the first application 100′ of the information security device 1′ of the receiver as a response. The first application 100′ may receive the allowance result whether decryption is possible, from the information security server 2.

If the received result is an allowance for decryption, the button 405, 409 for commanding decryption may be displayed on the screen of the second application 200′ of the information security device 1′ of the receiver. If the decryption button 405, 409 is selected by the user, the first application 100′ of the information security device 1′ of the receiver may combine the first encrypted characters and the second encrypted characters, and may decrypt the combined encrypted characters by using the decryption key (S16).

In the above embodiments, the term “unit” is not used to distinguish hardware components of the information security device 1. Thus, a plurality of components may be integrated into one component, and one component may be divided into a plurality of components. In addition, the component may mean a hardware component but may also mean a software component. Thus, it should be understood that the present disclosure is not specially limited by the term “unit”.

Though the present disclosure has been described based on the embodiments and the drawings, the present disclosure is not limited thereto, but various changes and modifications can be made by those skilled in the art within the equivalent scope of the present disclosure and the appended claims.

1-23. (canceled)

24. An information security device, comprising: at least one processor;
memory; and one application stored in the memory and executable by the at least one processor, the one application comprising instructions to:
receive one or more characters, which are input to an other application, from the other application through an accessibility feature;
encrypt the one or more characters received from the other application;
replace the one or more characters input to the other application with the encrypted one or more characters;
receive one or more characters, which are output from the other application, from the other application through the accessibility feature;
check whether the one or more characters output from the other application are encrypted;
decrypt the one or more characters output from the other application; and
output the decrypted one or more characters on the other application.

25. The information security device of claim 24, wherein the one application displays the encrypted or decrypted one or more characters on the input or output one or more characters of the other application in an overlay manner.

26. The information security device of claim 24, wherein the one application, when the one or more characters input to the other application are selected by a user, receives the input one or more characters from the other application through the accessibility feature and provides an interface for requesting encryption of the input one or more characters on a screen of the other application.

27. The information security device of claim 24, wherein the encrypted one or more characters include information indicating that the one or more characters output from the other application are encrypted.

28. The information security device of claim 24, wherein the one application, when information indicating that the output one or more characters are encrypted is included in the one or more characters output from the other application, provides an interface for requesting decryption of the output one or more characters on a screen of the other application.

29. The information security device of claim 24, wherein the one application, when the one or more characters encrypted and output from the other application are selected by a user, receives the output one or more characters from the other application through the accessibility feature and provides an interface for requesting decryption of the output one or more characters on a screen of the other application.

30. The information security device of claim 24, wherein the one application transmits, to a server, information of a first user who has performed encryption and one or more second users who have authority for decryption, and the one application receives, from the server, information indicating that one or more characters are encrypted.

31. The information security device of claim 24, wherein the one application, when the one or more characters output from the other application include unique identification information indicating that the output one or more characters are encrypted, sends user identification information of the information security device's user and the unique identification information to a server.

32. The information security device of claim 31, wherein the server checks whether the user identification information sent from the one application corresponds to information of one or more users, having decryption authority, which are stored in the server, and the one application provides an interface for requesting decryption of the output one or more characters on a screen of the other application.

33. The information security device of claim 31, wherein when the server determines that the information security device's user has decryption authority, the one application receives a decryption key from the server and decrypts the one or more characters output from the other application by using the decryption key.

34. The information security device of claim 24, wherein the one application checks whether the one or more characters output from the other application are encrypted by using unique identification information indicating that one or more characters are encrypted, wherein the unique identification information is included in the one or more characters output from the other application.

35. The information security device of claim 24, wherein the one application divides the encrypted one or more characters into a first character set and a second character set, sends the first character set of the divided characters to an other information security device, and sends the second character set of the divided characters to a server so that the server stores the second character set of the divided characters.

36. The information security device of claim 35, wherein the one application receives the second character set of the divided characters from the server and combines the first character set of the divided characters and the second character set of the divided characters received from the server.

37. An information security method, comprising:
receiving, by one application, one or more characters, which are input to an other application, from the other application through an accessibility feature, the one application and the other application stored in memory and executable by at least processor;
encrypting, by the one application, the one or more characters received from the other application;
replacing, by the one application, the one or more characters input to the other application with the encrypted one or more characters;
receiving, by the one application, one or more characters, which are output from the other application, from the other application through the accessibility feature;
checking, by the one application, whether the one or more characters output from the other application are encrypted;
decrypting, by the one application, the one or more characters output from the other application; and
outputting, by the one application, the decrypted one or more characters on the other application.

38. The information security method of claim 37, wherein the one application displays the encrypted or decrypted one or more characters on the input or output one or more characters of the other application in an overlay manner.

39. The information security method of claim 37, wherein the one application, when the one or more characters input to the other application are selected by a user, receives the input one or more characters from the other application through the accessibility feature and provides an interface for requesting encryption of the input one or more characters on a screen of the other application.

40. The information security method of claim 37, wherein the encrypted one or more characters include information indicating that the one or more characters output from the other application are encrypted.

41. The information security method of claim 37, wherein the one application, when the one or more characters encrypted and output from the other application are selected by a user, receives the output one or more characters from the other application through the accessibility feature and provides an interface for requesting decryption of the output one or more characters on a screen of the other application.

42. The information security method of claim 37, wherein the one application transmits, to a server, information of a first user who has performed encryption and one or more second users who have authority for decryption, and the one application receives, from the server, information indicating that one or more characters are encrypted.

43. The information security method of claim 37, wherein the one application divides the encrypted one or more characters into a first character set and a second character set, sends the first character set of the divided characters to an other information security device, and sends the second character set of the divided characters to a server so that the server stores the second character set of the divided characters.
